(19) United States
(12) Patent Application Publication
(10) Pub. No.: US 2018/0085866 A1
(43) Pub. Date: Mar. 29, 2018

(54) WIRE ROPE TUBE CLAMP DEVICE

(71) Applicant: Roman Alaniz, Rosenberg, TX (US)

(72) Inventor: Roman Alaniz, Rosenberg, TX (US)

(21) Appl. No.: 15/276,799

(22) Filed: Sep. 27, 2016

(51) Int. Cl. B23K 37/053; B25B 27/16

(52) U.S. Cl. CPC B23K 37/0533; B23K 2201/06; B25B 27/16

(57) ABSTRACT

An adjustment device to align a plurality of tube sections is disclosed. The device comprises at least two sheave sections fixedly attached to a threaded shaft via a socket assembly, wherein the threaded shaft substantially extends in a longitudinal direction to meet a base plate. An adjusting means positioned at an upper end of the threaded shaft is configured to radially align the base plate along the confronting ends of the tube sections via a plurality of wire rope wound around the sheave section. The adjusting means comprises a socket and a ratchet to adjust the device to align the tube sections and the plurality of wire rope (conform a basket hitch) the confronting ends of the tube sections for alignment in a limited room for space.

### BACKGROUND

In numerous applications, the tube sections are usually welded together for making a tube assembly. The confronting ends of these tube sections are positioned in close proximity and joined by the welding process. The alignment of the confronting ends of these tube sections is checked before welding the tubes to see any size irregularities of the tubes so that they can fit them properly. The size irregularities such as change in dimensions and thickness may hinder the effective welding process. Further, based on the application area, such as enabling the fitting process to occur in tight areas faces more complications as there is no room for adjustment.

In some cases, the shape of the tube section is adjusted to reduce the difference in configuration of the adjoining tube sections which requires more manual effort and is a time consuming process. Further, the alignment of these tube sections will not be conforming. Many prior attempts were aimed at providing devices and tools having clamping features and angled fasteners to accomplish the alignment. However, the design of the device was cumbersome and does not help in versatile application areas. Many devices such as rigging equipment's, slings, wedges and pry bars were used to align the tube sections. However, when aligning tubes using these devices for proper fit up to be welded, the process can be difficult in tight areas.

Prior art reference U.S. Pat. No. 6,641,124 discloses a clamping device for aligning the confronting ends of a pair of tube members in order to position the tube members for welding. However, the device does not assist the alignment process to be carried out effectively especially in tight areas where there is no room for adjustment. Further, the device cannot be kept easily on the tubes when the tubes to be fitted are placed very close to each other.

In light of the aforementioned drawbacks and limitations, there exists a need for a clamping device with an adjusting mechanism to enable the fitting process of tube sections in limited space applications.

### SUMMARY

The objective of the present invention is to provide an adjustment device to align a plurality of tube sections and enable the fitting process in places wherein limited room for space is available.

According to one embodiment of the present invention, the adjustment device comprises at least two sheave sections fixedly attached to a threaded shaft via a socket assembly, wherein the threaded shaft substantially extends in a longitudinal direction to meet a base plate. The adjustment device also comprises an adjusting means positioned at an upper end of the threaded shaft is configured to radially align the base plate along the confronting ends of the tube sections via a plurality of wire ropes wound around the sheave section.

According to another embodiment of the present invention, the sheave sections and the socket assembly are configured to slide along the threaded shaft to fix the base plate along the confronting ends of the tube sections. The base plate comprises an angled configuration to align the confronting ends of the tube sections.

### BRIEF DESCRIPTIONS OF SEVERAL VIEWS OF DRAWINGS

FIG. 1 illustrates a perspective view of an adjustment device to align a plurality of tube sections, according to an embodiment of the present invention.

FIG. 2 illustrates the adjustment device to align the plurality of tube sections, according to another embodiment of the present invention.

### DETAILED DESCRIPTION OF DIFFERENT EMBODIMENTS

The present invention is related to an adjustment device 100 to align a plurality of tube sections (102a, 102b) and enable the fitting process in tighter space applications.

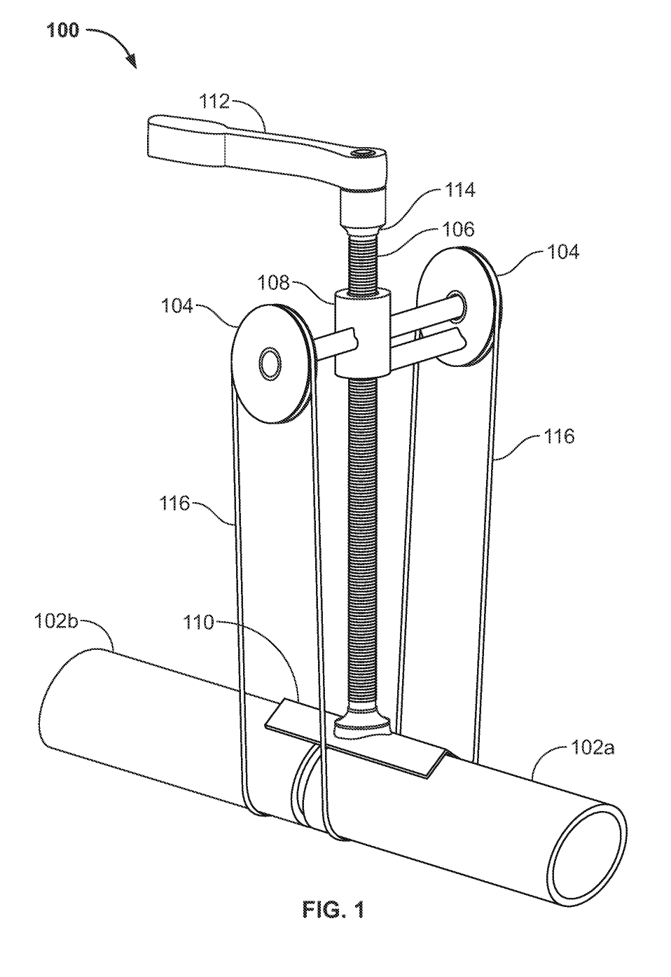

Referring now to FIG. 1 which illustrates perspective view of an adjustment device 100 to align a plurality of tube sections (102a, 102b). The adjustment device 100 comprises at least two sheave sections 104 fixedly attached to a threaded shaft 106 via a socket assembly 108, wherein the threaded shaft 106 substantially extends in a longitudinal direction to meet a base plate 110. An adjusting means 112 positioned at an upper end 114 of the threaded shaft 106 is configured to radially align the base plate 110 along the confronting ends of the tube sections (102a, 102b) via a plurality of wire rope 116 wound around the sheave section 104. The adjusting means 112 comprises a socket and a ratchet to adjust the device 100 to align the tube sections (102a, 102b) and the plurality of wire rope 116 basket hitches the confronting ends of the tube sections (102a, 102b) for alignment in a limited room for space.

In an embodiment, according to the present invention, the sheave sections 104 and the socket assembly 108 are configured to slide along the threaded shaft 106 to fix the base plate 110 along the confronting ends of the tube sections (102a, 102b). The sheave section 104 comprises a recessed area to receive and position the wire rope 116. The sheave section 104 is generally made from a wire rope material. The wire rope 116 wound around the sheave section 104 is configured to provide a basket hitch to align the confronting ends of the tube sections (102a, 102b). The wire rope 116 are made from a hardened steel to provide rigidity to hold the tube sections (102a, 102b) together when the adjustment device 100 is deployed. A pair of sheave sections 104 is fixedly attached to the threaded shaft 106 via a socket assembly 108. The sheave sections 104 are rigidly attached to the threaded shaft 106 as the wire rope 116 wound on the recessed area of the sheave section 104 adds pressure on the sheave section 104 when the adjustment device 100 is deployed.

Referring to FIG. 1, the adjusting means 112 is a ratchet assembly attached to the socket configured to manually operate the adjustment device 100 by a user. In different embodiments, other means of adjusting mechanism 112 can also be used to accomplish the task. The base plate 110 is configured to fix the confronting ends of the tube sections (102a, 102b) rigidly when the wire rope 116 secures the tube sections (102a, 102b) radially. The base plate 110 comprises an angled configuration so that the upper surfaces of the tube sections (102a, 102b) to be joined are properly aligned enabling the user to weld in areas where tighter space limitations are there.

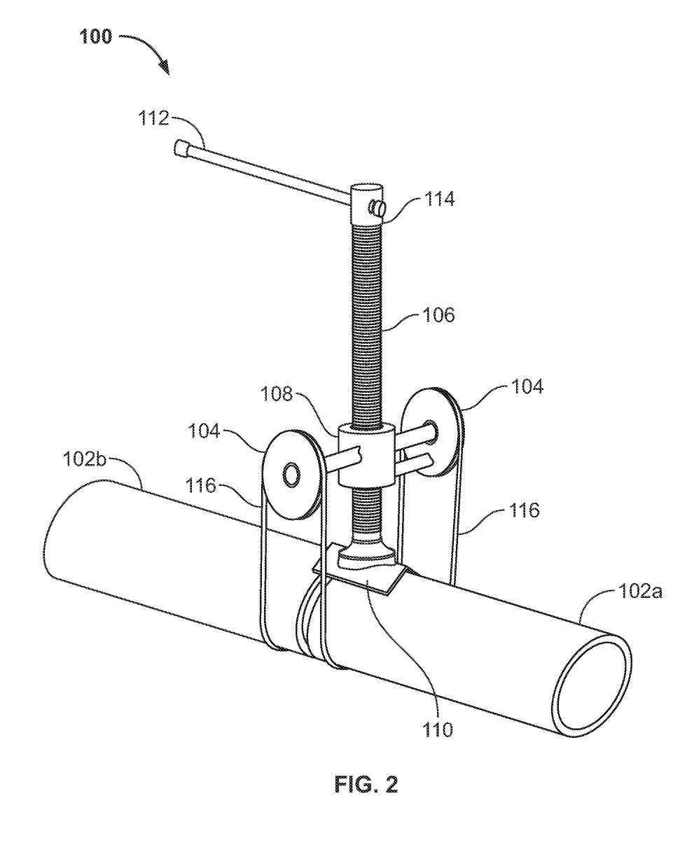

According to an exemplary embodiment as shown in FIG. 2, a method of aligning the tube sections (102a, 102b) using the adjustment device 100 is also disclosed. The user needs to place the adjustment device 100 on the confronting ends of the tube sections (102a, 102b) that has to be joined. The angled configuration of the base plate 110 is made to sit on the upper surfaces of the tube sections (102a, 102b) and the user can adjust the adjusting means 100 such as the ratchet assembly to tighten the wire rope 116 wounded on the pipe sections (102a, 102b). The wire rope 116 radially surrounds the tube sections (102a, 102b) and forms a basket hitch, to hold the confronting ends together such that the user can weld the sections for extended use.

According to an exemplary embodiment, the adjustment device 100 uses the modified 5/16″ (inch) socket and ratchet to adjust the device 100. The steel sheave section 104 is configured to have 3/16″ (inch) cable×2″ (inch) dimension. The threaded shaft 106 is made from a modified C Clamp 8″ (inch) long steel and the angled base plate 110 is configured to have 1½″ (inch)×6″ (inch) dimension. However, these sizes are not limited to and can have different size capabilities to accomplish the task. Depending on the job site and size limitations of the tubes, the adjustment device 100 can be made at different specifications accordingly.

The adjustment device 100 according to the present invention, is able to snake through the tight space in between the tube sections (102a, 102b) and then begin the alignment process because of its very small diameter. In applications such as boilers and power plants, the tube sections (102a, 102b) that are welded comes out of elements that transfers steam and therefore these sections are placed extremely close to one another sometimes as close as an ⅛ of an inch. The adjustment device 100 easily goes inside such tight spaces and helps to clamp and align the tube sections (102a, 102b) before the welding process. The basket hitch (wire rope) 116 in the adjustment device 100 enables the fitting process to occur in tight areas where the clearance is as tight as ⅛ or depending on size of the wire rope 116. The compact size of the wire rope 116 which has smaller diameter, enables the adjustment device 100 to work in tight areas by easily slipping through the tube sections (102a, 102b) that has to be welded. The adjustment device 100 also allows for easy accessibility for tacking tube joints. Using this device, the manufacturing and maintenance process of the tube sections (102a, 102b) becomes cheaper, reliable and economical.

Although the present invention has been described herein in the context of a particular implementation in a particular environment for a particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein.

I claim:

1. An adjustment device to align a plurality of tube sections, the device comprising:
at least two sheave sections fixedly attached to a threaded shaft via a socket assembly, wherein the threaded shaft substantially extends in a longitudinal direction to meet a base plate;
an adjusting means positioned at an upper end of the threaded shaft is configured to radially align the base plate along the confronting ends of the tube sections via a plurality of wire rope wound around the sheave section.

2. The device of claim 1, wherein the adjusting means comprises a socket and a ratchet to adjust the device to align the tube sections.

3. The device of claim 1, wherein the sheave section comprises a recessed area to receive and position the wire rope.

4. The device of claim 1, wherein the sheave sections and the socket assembly are configured to slide along the threaded shaft to fix the base plate along the confronting ends of the tube sections.

5. The device of claim 1, wherein the base plate comprises an angled configuration to align the confronting ends of the tube sections.

6. The device of claim 1, wherein the base plate is made from a hardened iron material.

7. The device of claim 1, wherein the plurality of wire rope, basket hitches the confronting ends of the tube sections for alignment in a limited room for space.

8. The device of claim 1, wherein the sheave section is made from a steel material.

9. The device of claim 1, wherein the wire rope wound around the sheave section is configured to provide a modified C-clamp to align the confronting ends of the tube sections.
